(19) United States
(12) Patent Application Publication
(10) Pub. No.: US 2007/0287131 A1
(43) Pub. Date: Dec. 13, 2007

(54) Method for Production of a Denture

(75) Inventors: KLAUS RUPPERT, Maintal und (DE); KARL-HEINZ RENZ, Frankfurt (DE)

Correspondence Address: NORRIS, MCLAUGHLIN & MARCUS, PA, 875 THIRD AVENUE, 18TH FLOOR, NEW YORK, NY, 10022, US

(73) Assignee: HERAEUS KULZER GMBH, Hanau (DE)

(21) Appl. No.: 11/759,300

(22) Filed: Jun. 7, 2007

(30) Foreign Application Priority Data
Jun. 7, 2006 (DE) 10 2006 026 776.1

(51) Int. Cl. A61C 5/10

(52) U.S. Cl. 433/223

(57) ABSTRACT

The present invention relates to a method for manufacturing dental prostheses according to a digitized virtual model which reflects the maximally situation, comprising the steps providing a data record that reflects the maxillary situation and relationship, digital modeling of the tooth, creating a divided negative mold (rapid manufacturing) from the data from the digital tooth modeling, insertion of the fabricated teeth into the opened negative mold, closing the negative mold, filling the remaining cavity with plastic for the prosthesis.

The present invention relates to the production of a denture, in particular dental prostheses, crowns and bridges.

Dental technology for production of prosthetic devices (crowns, bridges, prostheses) is known and has been described in detail in the literature. In the traditional production of full dentures, essentially the following steps are run through:
The dentist takes an impression,
A model that reproduces the dentofacial situation is created,
The artificial teeth are created in wax and the gingival is modeled,
The wax prosthesis is embedded in plaster,
The wax is removed,
The resulting cavity is filled with plastic for the prosthesis (e.g., PalaXpress).

There have been increasing attempts to simplify this complex procedure. For example, the company Heraeus Kulzer presented their product Filou 28® at the International Dental Exhibition in 2005.

This was a modeling aid for accurate positioning of artificial prosthetic lateral teeth in the jaw without any restriction on the patient's individual function pattern. All recognized “ideal occlusions” can be implemented with this new device by suitably fabricated and replaceable lateral tooth impression blocks. The labor is reduced here by up to 50% in comparison with previous dental aids.

So-called dental impressions are used here. These dental impressions, which define the complete maxillary/mandibular—lateral tooth block, are used for anatomically correct positioning of the artificial lateral teeth. The lateral tooth blocks can be shifted freely in all directions into the anatomically correct position for each patient and then secured there in a controllable manner.

Using a laser pointer, the precise spatial positioning is determined by specially positioned holes. This dental aid and/or “lateral tooth positioning gauge” can be folded upward so that the lateral teeth of the mandible can be positioned freely in the impressions and the base of each tooth can be adapted to the jaw profile. Then the device can be reset accurately to the chewing plane. The dental aid consists of a basic device and adapters for conventional articulators.

Furthermore, developments have already pointed toward an increasing digitization in dental technology. Already today, ceramic dental prosthetics are being produced by CAD/CAM technologies (e.g., Cercon, Degudent).

Rapid prototyping technologies are well known from the technical area and are enjoying increasing popularity. For example, U.S. Pat. No. 6,376,148 B1 describes the production of large objects made of material based on powder/liquid.

DE 101 14 290 B4 describes a rapid prototyping method for dental technology. The disadvantages of this method include the fact that an anisotropic design of the dental prosthesis is always built up layer by layer with layered structures, so that an aftertreatment is necessary, e.g., by additional light curing or thermal curing to achieve the required strength.

U.S. Pat. No. 7,029,275 and U.S. Pat. No. 7,027,642 describe scanning methods for taking three-dimensional images of the dentition. The use of prosthetic production is proposed: the traditional wax model can then be avoided by automating the method and creating virtual three-dimensional teeth. The jaws are scanned and stored as a virtual 3D model. Then virtual dental templates are drawn from the memory of the computer. These dental molds are adapted to the particular dimensions of the individual's jaw and modeled virtually. In this stage there is a virtual 3D model with teeth, gingiva and associated anatomical structures.

After this data record has been complied, the prosthesis should then be produced by milling or casting. A physical model can also be produced by stereolithography, after which the prosthesis is cast by the lost wax casting method of molding, which thus makes the entire procedure more complicated.

According to U.S. Pat. No. 6,821,462, ceramic dental restorations such as teeth or bridges are produced by using stereolithographic methods. To produce the master model, a shell is created by a rapid prototyping method. This shell may also be used as a wax mold for casting or pressure casting according to the known lost wax casting method. After producing the shell, a plaster model is cast by the conventional method. Ceramic, composite or metal may then be used to fill up the plaster mold.

Disadvantages of the direct rapid prototyping methods include the fact that with a layered structure the result is always an anisotropic structure of the dental prosthesis, thus requiring aftertreatment, e.g., by additional light curing or thermal curing to achieve the required strength. One disadvantage is that it is very difficult to achieve an aesthetic coloration.

The object of the present invention is then to avoid these disadvantages and nevertheless simplify the traditional process described above.

This object is achieved by the present invention as described herein.

According to this invention, the embedding which is required to produce the dental prosthesis is produced by a rapid prototyping method.

This invention thus relates to a method for producing dental prostheses according to a digitized virtual model which reproduces the shape of the jaw,

comprising the steps

Automatic digital modeling of the tooth (the teeth are fabricated teeth, e.g., from the company Heraeus Kulzer and are in a digitized form),
Digitally creating a divided negative mold (rapid manufacturing),
Inserting the fabricated teeth into the open negative mold,
Closing the open negative mold,
Filling the remaining cavity with plastic for the prosthesis by the usual methods, e.g., injection, stop-press technique.

The essentially known plastics may be used as plastics for prosthetics, e.g., PalaXpress from the company Heraeus Kulzer.

The immediate advantages of the method include:

Established dental materials can be processed and the functional and aesthetic properties are not impaired, as described above.

It is self-evident that the data from the virtual model can be obtained by the dentist either by scanning a model produced conventionally by taking an impression or by digitizing the jaw relationships using a suitable camera.

The automatic digital modeling is performed, e.g., in a virtual articulator such as that described in “Verbatim” Spring 2000 or U.S. Pat. No. 6,152,731 and U.S. Pat. No. 6,322,359.

Creation of the negative form may be accomplished by known methods such as milling methods (e.g., 5-axle milling), 3D pressure methods, stereolithography, laser sintering or other rapid prototyping methods.

The material for the negative mold should meet the following requirements:
have dimensional stability,
be nonelastic,
the mechanical strength should be below that of the material to be processed for the prosthesis so that in case of doubt the material of the negative mold will break,
it should not be connected to the plastic for the prosthetics and/or such a connection should be prevented by application of an insulation layer,
when using heat-curing prosthetic materials, the material for the negative mold should be thermally stable up to approximately 120° C.,
the material of the negative mold is advantageously transparent to allow observation of the complete filling of the cavity,
the material of the negative mold must not damage the fabricated tooth surface on insertion.

The advantages of the inventive method in comparison with the traditional method include:
saving of time in modeling of teeth,
cost of materials that must be used in the traditional method (e.g., dental wax, plaster) may be saved,
time savings in creating the dental prosthesis based on the total time involved.

The present invention also relates to a largely similar method for manufacturing definitive crowns and bridges made of ceramic according to a digitized virtual model which reflects the dentofacial situation, comprising the steps
providing a data record that reflects the digital molding of the jaw and tooth situation after preparation of the tooth,
creating a divided negative mold from this data record (rapid manufacturing) using a porous absorbent material that has dimensional stability, taking into account any shrinkage that occurs in sintering,
filling the remaining cavity with a ceramic slip,
unmolding after achieving dimensional stability,
optional further drawing,
sintering of the ceramic blank.

The present invention also relates to a method for producing temporary crowns and bridges according to a digitized virtual model which reproduces the jaw situation after dental preparation, comprising the steps
producing a divided negative mold (rapid manufacturing),
filling the remaining cavity with a temporary crown and bridge material,
polymerization of the temporary crown and bridge material.

The negative mold is preferably made of a transparent plastic to achieve a partial gelation of the crown and bridge material by light.

Finally, the present invention also relates to a method for manufacturing definitive crowns and bridges according to a digitized virtual model which reflects the jaw situation after preparation of a tooth,
comprising the step
creating a crown or bridge (rapid manufacturing) from dental materials such as light curing, self curing or dual curing composites, ceramics, noble metal or non-noble metal alloys.

The present invention will now be explained below on the basis of an example. First the maxillary and mucosal relationships are determined by digital modeling. By digital articulation, a dental model is created on the basis of the resulting model and a digital tooth molds. The artificial gingiva is modeled digitally. An enveloping surface is drawn around the combination of artificial teeth and artificial gingiva and embedding of this 3D object by means of an RP method is produced. The separation surface should run on the plane of the jawbone.

This is achieved by means of a constructive method using the Spectrum Z510 3D printer from the Z Corporation.

After applying a separation layer based on polyvinyl alcohol, for example, the fabricated teeth are inserted into the cavities provided for them and are preconditioned according to the manufacturer's instructions.

The plastic for the prosthesis based on methyl methacrylate is prepared in a sufficient quantity and is introduced into the divided mold and then the two mold halves are joined. The plastic is polymerized according to the manufacturer's instructions and then unmolded to yield a dental prosthesis suitable for incorporation.

What is claimed is:

1. A method for manufacturing a dental prosthesis according to a digitized virtual model, which reflects the maxillary situation, comprising:
a) providing a data record that reflects the maxillary situation and relationship,
b) digital modeling of the tooth,
c) creating a divided negative mold (rapid manufacturing) from the data from the digital tooth modeling,
d) inserting the fabricated teeth into the opened negative mold,
e) closing the negative mold, and
f) filling any remaining cavity with plastic for the prosthesis.

2. Method according to claim 1, wherein the remaining cavity is filled with plastic for the prosthesis by an injection method.

3. Method according to claim 1, wherein the remaining cavity is filled with plastic for the prosthesis according to the stop-press method.

4. Method according to claim 1, wherein the negative mold is manufactured from a plaster blank.

5. Method according to claim 1, wherein the negative mold is manufactured from a transparent plastic.

6. Method according to claim 1, wherein the digital tooth modeling is automated.

7. A method for producing a definitive crown and/or bridge from ceramic according to a digitized virtual model which reflects the maxillary situation, comprising:
a) preparing a data record that reflects the digital modeling of the maxillary and dental situation after the dental preparation,
b) creating a divided negative mold from this data record (rapid manufacturing) using a porous absorbent material having dimensional stability, taking into account any sintering shrinkage that may occur,
c) filling any remaining cavity with a ceramic slip,
d) unmolding after achieving dimensional stability,
e) optionally further drying, and
f) sintering the ceramic blank.

8. Method according to claim 7, wherein the negative mold is made of plaster.

9. A method for manufacturing a temporary crown and/or bridge according to a digitized virtual model that reflects the maxillary situation after dental preparation, comprising:
a) creating a divided negative mold from the digitized virtual model (rapid manufacturing),
b) filling any remaining cavity with a temporary crown and bridge material, and
c) polymerizing the temporary crown and bridge material.

10. Method according to claim 9, wherein the negative mold is manufactured from a transparent plastic to achieve partial gelation of the crown and bridge material by light.
